(19) United States
(12) Patent Application Publication
(10) Pub. No.: US 2007/0196585 A1
(43) Pub. Date: Aug. 23, 2007

(54) Method of applying a phenolic resin corrosion protective coating to a steel component

(76) Inventors: Bradford G. Corbett SR., Fort Worth, TX (US); Mark Weih, Apex, NC (US); Jorge Arias, San Jose (CR)

Correspondence Address: Charles D. Gunter, Jr.;Whitaker, Chalk, Swindle & Sawyer, LLP, 3500 City Center Tower II, 301 Commerce Street, Fort Worth, TX, 76102-4186, US

(21) Appl. No.: 11/656,722

(22) Filed: Jan. 23, 2007

Related U.S. Application Data
(63) Continuation-in-part of application No. 10/788,955, filed on Feb. 27, 2004, now abandoned.
(60) Provisional application No. 60/506,074, filed on Sep. 24, 2003.

(51) Int. Cl. B05D 1/36; B05D 7/00

(52) U.S. Cl. 427/409; 427/202

(57) ABSTRACT

A method is shown for corrosion protecting both ductile iron and steel components, such as components used in a pipeline which forms a part of a water or sewer line used in the waterworks industry as a part of a fluid conveyance system. A surface of the component is coated with a corrosion resistant coating which is an aqueous phenolic resin dispersion. The component is dipped in a bath of the corrosion resistant coating and then baked, dried and cooled. An electrostatic powder coating is applied over the base phenolic resin coating for added corrosion protection and durability.

### CROSS REFERENCE TO RELATED APPLICATIONS

The present application is a continuation-in-part of earlier filed application Ser. No. 10/788,955, filed Feb. 27, 2004, entitled “Protective Coating Compositions and Techniques For Fluid Piping Systems”, which, in turn, claimed priority from provisional application Ser. No. 60/506,074, filed Sep. 24, 2003, entitled “Corrosion Resistant Coating for Ductile Iron Pipe”, by Bradford Corbett, Sr. And Jorge Arias.

### BACKGROUND OF THE INVENTION

1. Field of the Invention

This invention relates generally to corrosion protection for piping systems of the type used in fluid conveyance, as well as for steel and metal parts generally, which system provides an environmentally friendly and cost effective alternative to traditional galvanization processes.

2. Description of the Prior Art

In one field of use, the present invention deals with corrosion protection of ferrous metal piping systems and components thereof of the type used in water, sewage, and other municipal fluid conveyance systems. By “ferrous metal” is meant iron and alloys of iron, for example, cast iron. One particular type of ferrous metal which is commonly encountered in the waterworks industry is “ductile iron”. This particular type of metal is widely used because it offers a combination of a wide range of high strength, wear resistance, fatigue resistance, toughness and ductility in addition to the well-known advantages of cast iron—castability, machinability, damping properties, and economy of production. It takes its name from the fact that it is “ductile” in nature, rather than being brittle, as was the case with earlier cast iron products and materials.

As a result of the above described advantages of ductile iron, it has become widely adopted in the waterworks industry. One disadvantage of pipes, components, accessories and fittings (piping systems) made from ductile iron, however, is that such products are subject to corrosion and degradation in the normal storage and work environment. For example, lengths of pipe, as well as glands, fittings and restraint mechanisms if the type commonly used in the waterworks industry are typically stored prior to use at a warehouse or in a field location. Moisture and oxidation inevitably cause rust and corrosion.

Corrosion affects not only the appearance of ferrous metals used in fluid conveyance systems, but can also rust, pit, scar or otherwise degrade the exposed surfaces of such materials. This is especially true in the case of an accessory or associated component of the ferrous metal piping system which may be formed of ferrous metal or of steel or another metal alloy. For example, the accessory component may include glands, fittings, mechanical joints, push-on fittings, restraint joint devices, nuts, bolts and external wedge devices, and the like. Many of these type items have included historically difficult surfaces that are designed with an irregular geometry having projections and depressions, such as gripping inserts or similar teethed surfaces. As a result, various coating technologies have been developed over the years to combat the problem of corrosion in these and other exposed metal surfaces.

One technique which has been known for many years in the corrosion protection arts generally is commonly referred to as “galvanization.” This term originally referred to a processes of electrodeposition. However, today the term “galvanization” has largely come to be associated with zinc coatings, to the exclusion of other metals. In current use, it typically means hot-dip galvanizing, a chemical process that is used to coat steel or iron with zinc. This is done to reduce corrosion (specifically rusting) of the ferrous item and, while it is accomplished by non-electrochemical means, it serves an electrochemical purpose.

The basic steps of the galvanization process are as follows. First, alkaline or acid degreasing is carried out to remove rust and clean the surface of the metal. Next, fluxing takes place to protect the active surface of the metal from oxidation and to improve the wetting of the metal surface by molten zinc in the galvanization step. Afterwards, the metal is dipped in a bath of molten zinc. Continuous galvanization is similar, except that fluxing is typically not included since there is generally no significant delay before the prepared metal is dipped in the molten zinc. Alternatively, in a continuous galvanization process, the metal may be placed in a furnace and subjected to a reducing atmosphere prior to dipping in the molten zinc.

Zinc coatings prevent oxidation of the protected metal by forming a barrier, and by acting as a sacrificial anode if this barrier is damaged. Zinc oxide is a fine white dust that (in contrast to iron oxide) does not cause a breakdown of the substrate's surface integrity as it is formed. Indeed the zinc oxide, if undisturbed, can act as a barrier to further oxidation, in a way similar to the protection afforded to aluminum and stainless steels by their oxide layers.

Hot dip galvanizing deposits a thick, robust layer that may be more than is necessary for the protection of the underlying metal in some applications. This is the case in automobile bodies, where additional rust proofing paint will be applied. Here, a thinner form of galvanizing is applied by electroplating, called “electro-galvanization”. However, the protection this process provides is insufficient for products that will be constantly exposed to corrosive materials such as a spray of salt water, the traditional measure of a coating's effectiveness.

Despite the various advantages offered by traditional galvanization processes, the presently practiced methods are subject to rapidly increasing costs. There are also pervasive environmental problems associated with the process as well as various performance limitations.

A need exists, therefore, for an improved technique for protecting piping systems of the type used in fluid conveyance from corrosion and other detrimental environmental factors present in the field or in the manufacturing or storage facility.

A need exists for such an improved technique which could be used to provide improved corrosion protection for cast and ductile iron pipe of the type used in fluid conveyance systems and particularly in the waterworks industry.

A need also exists for such a coating system which similarly provides adequate corrosion resistance to the glands, fittings, gripping rings and teeth, repair clamps, bands, and other associated components and accessories of such piping systems used for fluid conveyance.

A need also exists for an improved corrosion protection system generally which would provide an environmentally friendly and cost effective alternative to traditional galvanization processes.

### SUMMARY OF THE INVENTION

In one aspect, the present inventive method is used to provides a component of a ferrous metal piping system, such as a waterworks pipe, with improved corrosion resistance. The method starts with a pipe body formed of a ferrous metal, the pipe body having an exterior surface and an interior surface, a length and opposing end openings. A corrosion resistant coating is applied to at least a selected one of the exterior and interior surfaces, the corrosion resistant coating comprising an aqueous phenolic resin dispersion. Preferably, the coating is applying by dipping the pipe body in the aqueous phenolic resin dispersion so that both the exterior and interior surfaces are coated.

The preferred aqueous phenolic resin dispersion is a high molecular weight resin that is modified to include pendant ionic moieties on a phenolic backbone structure. The coating preferably comprises a continuous aqueous phase and, dispersed within the aqueous phase, the reaction product of a phenolic resin precursor and a modifying agent, wherein the modifying agent includes at least one ionic group and at least one functional moiety that enables the modifying agent to undergo condensation with the phenolic resin precursor. The resulting dispersed phenolic resin reaction product includes at least one phenolic ring to which is bound to the ionic group from the modifying agent. The preferred modifying agents may include an aromatic compound or a sulfate, sulfonate, sulfinate, sulfenate or oxysulfonate and the reactive functional moiety can be a hydroxy or hydroxyalkyl.

The component of the piping system being treated in the method of the invention can also include an accessory or associated component of the ferrous metal piping system. For example, the accessory component may include glands, fittings, mechanical joints, push-on fittings, restraint joint devices, nuts, bolts and external wedge devices, and the like. The present invention teaches a treatment technique that can be used on historically difficult surfaces that are designed with an irregular geometry having projections and depressions, such as gripping inserts or similar teethed surfaces. In the case of an accessory component, the component typically has a ferrous metal body having an exposed exterior surface. The corrosion resistant coating is applied to at least the exposed exterior surface, the corrosion resistant coating comprising the previously described aqueous phenolic resin dispersion.

In one preferred method of practicing the method of the invention, the ferrous metal component is coated with a corrosion resistant coating by subjecting the exposed metal surface to a treatment solution which comprises an aqueous phenolic resin dispersion as described above and optionally an acid and a flexibilizer. Preferably, the ferrous metal device is dipped into a treatment solution which includes the aqueous phenolic resin dispersion and at least an acid. One preferred acid is phosphoric acid. The preferred phenolic resin can be selected from the group consisting of Novolak resins and Resole resins. By dipping the ferrous metal device into a bath of the aqueous phenolic dispersion and acid, the coating autodeposits onto the exposed metal surface.

After the metallic component is dipped into the treatment solution, baked and dried, the present invention further applied a powder coating to the metallic component. The preferred powder coating is a dry type of coating, and is applied as a free-flowing, dry powder. The powder coating is typically applied electrostatically, followed by a curing step under heat to allow it to flow and form a permanent outer layer or covering.

The coating process of the invention can be used to coat a wide variety of metal substrates, including steel and other metals and metal alloys to provide improved corrosion protection.

Additional objects, features and advantages will be apparent in the written description which follows.

### BRIEF DESCRIPTION OF THE DRAWINGS

FIG. 1 is an end view of a gland in place on a section of ductile iron pipe, the gland and pipe having been treated with a corrosion resistant coating according to the technique of the present invention.

FIG. 2 is a partial cross sectional view of the pipe and gland of FIG. 1 showing the bolts which are used to form a secure joint of pipe in the fluid conveyance system.

FIG. 3 is a view similar to FIG. 2, but showing another type of gland fitting in which a combined sealing ring and gripping element are utilized.

FIG. 4 is an exploded view of a plastic pipe joint used in a water or sewer line, the female end of the joint being shown partly broken away and in section to better illustrate the metallic gripping element which is treated according to the principles of the invention.

FIG. 5 is a simplified flow diagram of the technique of the invention as used to coat a gland for a mechanical restraint which is used to join sections of ferrous metal pipe used in a fluid conveyance system.

### DETAILED DESCRIPTION OF THE INVENTION

The techniques of the present invention are used for coating ferrous metal piping systems of the type used in fluid conveyance, such as cast and ductile iron pipes, components and accessories used in the waterworks industry. In another field of endeavor, the techniques of the invention can be applied to the ferrous metallic, steel, and other metal and metal alloy components of plastic pipe systems of the type used in the waterworks industry. The coating techniques of the invention can be used to provide corrosion resistance to a surface, protecting the underlying surface from physical degradation, rust and corrosion, and rendering the surface water-resistant. The technique of the invention will first be described with reference to the waterworks industry and sections of cast and ductile iron pipe. However, the techniques can also be applied to components and accessories, including but not limited to glands, fittings, gripping rings and teethed surfaces or similarly designed surfaces with irregular geometry having projections and depressions, mechanical joints, push-on fittings, restraint joint devices, nuts, bolts, external wedge devices, gears, spline shafts, as well as other accessories and components formed of ferrous metals and steel used in pipelines in the water works industry. The coating techniques can also be used to coat metal objects to provide a more environmentally friendly and cost effective alternative to traditional galvanization methods of corrosion protection.

The coating techniques of the invention can be advantageously employed for protecting surfaces of ferrous metals, i.e., iron and iron alloys, and more particularly, for coating pipe such as ductile iron pipe. The coating techniques of the invention are useful for coating both the interior and the exterior of a pipe, component or accessory of a ferrous metal piping system. The surface may be arcuate, such as the exterior surface of a pipe or flat. The surface also may be an irregular geometry having projections and depressions such as a teethed surface, gear or spline shaft. While the coating is well suited for use on curved and arcuate pipe surfaces, due to its setting characteristics and lack of “sag”, the coating is not specifically limited to use on any particular surface geometry.

The preferred ferrous metals to be treated with the treatment system of the invention are cast and ductile irons. The modern ductile iron family includes materials offering a range of properties including ferritic ductile iron, ferritic pearlitic ductile iron, pearlitic ductile iron, all of which will be familiar to those skilled in the relevant arts. These types of materials offer an iron with high strength, good wear resistance, and moderate ductility and impact resistance. Machinability is also superior to steels of comparable physical properties.

The preceding three types of ductile iron are the most common and are usually used in the as-cast condition, but ductile iron can be also be alloyed and/or heat treated to provide, for example, the following grades for a wide variety of additional applications: martensitic ductile iron, bainitic ductile iron, austenitic ductile iron, and austempered ductile iron.

In a first aspect of the corrosion protection technique of the invention, a pipe, component or accessory of a ferrous metal piping system is coated with a corrosion resistant coating which is applied to at least a selected exposed surface thereof, the corrosion resistant coating comprising an aqueous phenolic resin dispersion. The preferred aqueous phenolic resin dispersion is a high molecular weight resin that is modified to include pendant ionic moieties on a phenolic backbone structure. The coating preferably comprises a continuous aqueous phase and, dispersed within the aqueous phase, the reaction product of a phenolic resin precursor and a modifying agent, wherein the modifying agent includes at least one ionic group which aids in maintaining the stability of the aqueous dispersion and at least one functional moiety that enables the modifying agent to undergo condensation with the phenolic resin precursor. The resulting dispersed phenolic resin reaction product includes at least one phenolic ring to which is bound the ionic group from the modifying agent. Preferred modifying agents include aromatic compounds as well as a sulfate, sulfonate, sulfinate, sulfenate or oxysulfonate with the preferred reactive functional moiety being a hydroxy or hydroxyalkyl.

One commercially available phenolic resin dispersion is sold commercially by Lord Corporation under the METALJACKET™ family of coatings. Formulation of one suitable phenolic resin dispersion for purposes of the present invention can be described with reference to the following issued U.S. Pat. Nos. 6,130,289; 6,383,307; 6,476,119; and 6,521,687, the disclosure of which is incorporated herein by reference to the extent that it is not reproduced in the written description which follows. The formulation and use of this family of aqueous based, phenolic resin dispersions will be recapped below with reference primarily to issued U.S. Pat. No. 6,383,307, issued May 7, 2002, to Kucera et al., entitled “Aqueous Metal Treatment Composition” and U.S. Pat. No. 6,130,289, issued Oct. 10, 2002, to Kucera, entitled “Aqueous Phenolic Dispersion.”

Description of METALJACKET™ Chemistry:

The family of aqueous phenolic dispersions which are useful in practicing will first be described with respect to the above mentioned METALJACKET™ family of coatings. These coatings are highly reactive, highly functional, hydrophilic phenolic resins which can be stabilized in an aqueous phase by modifying the phenolic resins to incorporate aromatic rings that have ionic pendant groups onto the phenolic resin structure. For example, the first component of the formulation can be a Novolak resin. This resin is responsible for the autodeposition characteristic of the metal treatment composition which will be described. The phenolic Novolak resin dispersion can be obtained by initially reacting or mixing a phenolic resin precursor and a modifying agent, theoretically producing a condensation reaction between the phenolic resin precursor and the modifying agent. The phenolic resin precursors can include both Novolak and Resole resins. However, the Resole resins cannot be used in or formulated into the metal treatment where the treatment also includes an acid component, as will be described. Under the acidic conditions of the metal treatment Resoles are unstable.

The aqueous dispersions also contain a “modifying agent” with two functional moieties. One functional moiety of the modifying agent provides the ionic pendant group that enables stable dispersion of the phenolic resin. Without the ionic pendant group, the phenolic resin would be unable to maintain a stable dispersion in water.

The other important functional moiety in the modifying agent enables the modifying agent to react with the phenolic resin precursor. The modifying agent can contain more than one ionic pendant group and more than one reaction-enabling moiety

Incorporation of aromatic sulfonate functional moieties into the phenolic resin structure via condensation is one method of providing the ionic pendant groups. Accordingly, one class of ionic moieties are substituents on an aromatic ring that include a sulfur atom covalently or ionically bonded to a carbon atom of the aromatic ring. Another example of a covalently bound substituent is sulfate ion. Sulfonate is one preferred ionic group.

The reaction-enabling functional moiety of the modifying agent can be any functional group that provides a site on the modifying agent for undergoing condensation with a phenolic resin. If the phenolic resin precursor is a Resole, the modifying agent reacts with an alkylol or benzyl ether group of the Resole. If the modifying agent is aromatic, the reaction-enabling functional moiety is a substituent on the aromatic ring that causes a site on the ring to be reactive to the alkylol or benzyl ether of the Resole precursor. An example of such a substituent is a hydroxy or hydroxyalkyl, with hydroxy being preferred. The hydroxy- or hydroxyalkyl-substituted aromatic modifying agent is reactive at a site ortho and/or para to each hydroxy or hydroxyalkyl substituent. In other words, the aromatic modifying agent is bonded to, or incorporated into, the phenolic resin precursor at sites on the aromatic ring of the modifying agent that are ortho and/or para to a hydroxy or hydroxyalkyl substituent. At least two reaction-enabling functional moieties are preferred to enhance the reactivity of the aromatic modifying agent with the phenolic resin precursor.

Alternatively, the reaction-enabling functional moiety of the modifying agent can be a formyl group, preferably attached to a carbon atom of an aromatic ring. In this instance, the phenolic resin precursor is a Novolak rather than a Resole. The Novolak precursor is reacted via an acid catalyzed aldehyde condensation reaction with the formyl group-containing modifying agent so that the formyl group forms a divalent methylene linkage to an active site on an aromatic ring of the backbone structure of the Novolak precursor. Consequently, the modifying agent structure (including the ionic moiety) is incorporated into the phenolic structure through the generated methylene linkage.

Another alternative reaction-enabling functional moiety could be a diazo group, preferably attached to a carbon atom of an aromatic ring. In this instance, the phenolic resin precursor is a Novolak rather than a Resole. The Novolak precursor is reacted via a diazo coupling reaction with the diazo group-containing modifying agent so that the diazo group forms a divalent diazo linkage to an active site on an aromatic ring of the backbone structure of the Novolak precursor. Consequently, the modifying agent structure (including the ionic moiety) is incorporated into the phenolic structure through the diazo linkage.

The modifying agent also can optionally include a functional moiety that is capable of chelating with a metal ion that is present on a substrate surface on which the phenolic resin dispersion is applied. The chelating group remains as a residual group after the condensation of the phenolic resin precursor and the aromatic modifying agent. Typically, the chelating group is a substituent on the aromatic ring that is capable of forming a 5- or 6-membered chelation structure with a metal ion. Examples of such substituents include hydroxy and hydroxyalkyl, with hydroxy being preferred. At least two such functional groups must be present on the modifying agent molecule to provide the chelating. In the case of an aromatic modifying agent, the chelating groups should be located in an ortho position relative to each other.

An aromatic modifying agent is particularly advantageous. Preferably, the ionic group and the reaction-enabling moiety are not substituents on the same aromatic ring. The ionic group, particularly sulfonate, appears to have a strong deactivating effect on condensation reactions of the ring to which it is attached. Consequently, an ionic group attached to the same ring as the reaction-enabling moiety would not allow the modifying agent to readily react with the phenolic resin. However, it should be recognized that this consideration for the location of the ionic and reaction-enabling moieties is not applicable to the formyl group-containing modifying agent and diazo modifying agent.

Illustrative aromatic modifying agents include salts of 6,7-dihydroxy-2-naphthalenesulfonate; 6,7-dihydroxy-1-naphthalenesulfonate; 6,7-dihydroxy-4-naphthalenesulfonate; Acid Red 88; Acid Alizarin Violet N; Erichrome Black T; Erichrome Blue Black B; Brilliant Yellow; Crocein Orange G; Biebrich Yellow; and Palatine Chrome Black 6BN. 6,7-dihydroxy-2-naphthalenesulfonate, sodium salt is the preferred aromatic modifying agent.

Any phenolic resin could be employed as the phenolic resin precursor, but it has been found that Resoles are especially suitable. The Resole precursor should have a sufficient amount of active alkylol or benzyl ether groups that can initially condense with the modifying agent and then undergo further subsequent condensation. The phenolic resin precursor has a lower molecular weight than the final dispersed resin since a the precursor undergoes condensation to make the final dispersed resin. Resoles are prepared by reacting a phenolic compound with an excess of an aldehyde in the presence of a base catalyst.

The reactants, conditions and catalysts for preparing Resoles suitable for the Resole precursor of the present invention are well-known. The phenolic compound can be any of those previously listed or other similar compounds, although multi-hydroxyphenolic compounds are undesirable. Particularly preferred phenolic compounds for making the Resole precursor include phenol per se and alkylated phenol. The aldehyde also can be any of those previously listed or other similar compounds, with formaldehyde being preferred. Low molecular weight, water soluble or partially water soluble Resoles are preferred as the precursor because such Resoles maximize the ability to condense with the modifying agent. The F/P ratio of the Resole precursor' should be at least 0.90. Illustrative commercially available Resoles that are suitable for use as a precursor include a partially water soluble Resole available from Georgia Pacific under the trade designation B.L. 2741 and a partially water soluble Resoles available from Schenectady International under the trade designations HRJ11722 and SG3100.

Preferably, the dispersed Novolak is produced by reacting or mixing 1 mol of modifying agent(s) with 2-20 mol of phenolic resin (preferably Resole) precursor(s) and, preferably, 2-20 mol of multi-hydroxyphenolic compound(s). An aldehyde compound, preferably formaldehyde, is also required to make the Novolak. The aldehyde compound can optionally be added as a separate ingredient in the initial reaction mixture or the aldehyde compound can be generated in situ from the Resole precursor. The Resole precursor(s), multi-hydroxy phenolic compound(s) and modifying agent(s) co-condense to form the dispersed Novolak. The reaction typically is acid catalyzed with an acid such as phosphoric acid. The F/P ratio of aldehyde compound(s) to combined amount of Resole precursor(s) and multi-hydroxy phenolic compound(s) in the initial reaction mixture preferably is less than 0.9. Preferably, synthesis of the dispersed Novolak is a two stage reaction. In the first stage, the Resole precursor(s) is reacted with the modifying agent(s) and, optionally, a small amount of multi-hydroxy phenolic compound(s). Once this first stage reaction has reached the desired point (i.e. the resin can be readily formed into a translucent dispersion), the acid catalyst and a greater amount of multi-hydroxy phenolic compound(s) is added to the reaction mixture. Pyrocatechol (also simply known as catechol) is a preferred multi-hydroxy phenolic compound for reacting in the first stage and resorcinol is a preferred multi-hydroxy phenolic compound for reacting in the second stage.

Hydrophilic Novolaks typically have a hydroxy equivalents of between 1 and 3 per aromatic ring. Preferably, dispersed hydrophilic Novolaks useful for the present purposes have a hydroxy equivalents of 1.1 to 2.5, more preferably 1.1 to 2.0. The hydroxy equivalents is calculated based on the amount of multi-hydroxy phenolic compounds used to make the Novolak.

If the modifying agent includes a sulfur-containing ionic group, the resulting modified phenolic resin should have a carbon/sulfur atom ratio of 20:1 to 200:1, preferably 20:1 to 100:1. If the sulfur content is greater than the 20:1 carbon/sulfur tom ratio, the modified phenolic resin begins to become water soluble, is more stable with respect to multivalent ions and is difficult to thermoset. These characteristics are adverse to the preferred use of the phenolic resin dispersion. If the sulfur content is below the 200:1 carbon/sulfur atom ratio, then the resin dispersion cannot maintain its stability. Viewed another way, the dispersed phenolic resins have 0.01 to 0.10, preferably 0.03 to 0.06, equivalents of sulfonate functionality/100 g resin. The aqueous dispersion of the phenolic resin preferably has a solids content of 1 to 50, preferably 15 to 30.

The modifying agent and the phenolic resin precursor can be reacted under conditions effective to promote condensation of the modifying agent with the phenolic resin precursor. The reaction is carried out in water under standard phenolic resin condensation techniques and conditions. The reactant mixture (including water) generally is heated from 50 to 100 degree C. under ambient pressure, although the specific temperature may differ considerably depending upon the specific reactants and the desired reaction product. The resulting product is a concentrate that is self-dispersible upon the addition of water and agitation to reach a desired solids content. The final dispersion can be filtered to remove any gelled agglomerations.

The intermediate modified Resoles or Novolaks that are initially produced in the synthesis are not necessarily water dispersible, but as the chain extension is advanced the resulting chain extended modified Resoles or Novolaks become progressively more water dispersible by simple mechanical agitation. The chain extension for the dispersed Resole is determined by measuring the viscosity of the reaction mixture. Once the Resole reaction mixture has a reached the desired viscosity, which varies depending upon the reactant composition, the reaction is stopped by removing the heat. The chain extension for the dispersed Novolak is determined by pre-selecting the F/P ratio of the total reaction mixture (in other words, the amount of aldehyde compound(s) relative to the amount of phenolic(s) in both the first and second stages). The reaction for the, Novolak is allowed to proceed until substantially all the total amount of the reactants have reacted. In other words, there is essentially no unreacted reactant remaining. Preferably, the molecular weight (i.e., chain extension) of the Novolak should be advanced to just below the gel point.

The amount of the Novolak dispersion present in the treatment formulations of the invention is not critical. Preferably, it is present in an amount of 1 to 20, more preferably, 2 to 6, weight percent based on the total weight of the non-volatile components of the composition.

The phenolic resin dispersion forms environmentally (especially corrosion) resistant, non-resolvatable films when applied to a metal surface and cured. As used herein, “non-resolvatable” means that the film does not resolvate when an aqueous covercoat is applied to the film before it is thermoset. If the film resolvated, the components of the film would dissolve or disperse into the aqueous covercoat thus destroying any advantage intended from the formation of the film on a surface. The low ionic content of the modified phenolic resin dispersion (relative to water soluble phenolic resins) allows them to behave similarly to non-ionically modified resins and form very water resistant films on curing.

In one aspect of the technique for coating ferrous metal piping systems, an acid is also incorporated into the aqueous phenolic resin dispersion. The acid can be any acid that is capable of reacting with a metal to generate multivalent ions. Illustrative acids include hydrofluoric acid, phosphoric acid, sulfuric acid, hydrochloric acid and nitric acid. In the case of steel the multivalent ions will be ferric and/or ferrous ions. Aqueous solutions of phosphoric acid are preferred. When the acid is mixed into the composition presumably the respective ions ate formed and exist as independent species in addition to the presence of the free acid. In other words, in the case of phosphoric acid, phosphate ions and free phosphoric acid co-exist in the formulated final multi-component composition. The acid preferably is present in an amount of 5 to 300 parts by weight, more preferably 10 to 1609 parts by weight, based on 100 parts by weight of the phenolic Novolak resin dispersion.

Water, preferably deionized water, is utilized in the metal treatment composition of the invention in order to vary the solids content. Although the solids content may be varied as desired, the solids content of the metal treatment composition typically is 1 to 10, preferably 3 to 6%. Since the metal treatment composition is waterborne it is substantially free of volatile organic compounds.

The resulting coating from application of the metal treatment composition is a thin, tightly bound interpenetrating organic/inorganic matrix of pheholic/metal phosphates at the metal substrate interface. This matrix can be further flexibilized with polymers. The flexibilizer is any material that contributes flexibility and/or toughness to the film formed from the composition. The toughness provided by the flexibilizer provides fracture resistance to the film. The flexibilizer should be non-glassy at ambient temperature and be an aqueous emulsion latex or aqueous dispersion that is compatible with the phenolic Novolak resin dispersion. The flexibilizer preferably is formulated into the composition in the form or an aqueous emulsion latex or aqueous dispersion.

Suitable flexibilizers include aqueous latices, emulsions or dispersions of (poly)butadiene, neoprene, styrene-butadiene rubber, acrylonitrile-butadiene rubber (also known as nitrile rubber), halogenated polyolefin, acrylic polymer, urethane polymer, ethylene-propylene copolymer rubber, ethylene-propylene-diene terpolymer rubber, styrene-acrylic copolymer, polyamide, poly(vinyl acetate) and the like. Halogenated polyolefins, nitrile rubbers and styrene-acrylic copolymers are preferred.

A suitable styrene-acrylic polymer latex is commercially available from Goodyear Tire & Rubber under the trade designation PLIOTEC and described, for example, in U.S. Pat. Nos. 4,968,741; 5,122,566 and 5,616,635. According to U.S. Pat. No. 5,616,635, such a copolymer latex is made from 45-85 weight percent vinyl aromatic monomers, 15-50 weight percent of at least one alkyl acrylate monomer and 1-6 weight percent unsaturated carbonyl compound. Styrene is the preferred vinyl aromatic monomer, butyl acrylate is the preferred acrylate monomer and acrylic acid and methacrylic acid are the preferred unsaturated carbonyl compound. The mixture for making the latex also includes at least one phosphate ester surfactant, at least one water-insoluble nonionic surface active agent and at least one free radical initiator.

If nitrile rubber is the flexibilizer, it is preferably mixed into the composition as an emulsion latex. It is known in the art that nitrile rubber emulsion latices are generally made from at least one monomer of acrylonitrile or an alkyl derivative thereof and at least one monomer of a conjugated diene, preferably butadiene. According to U.S. Pat. No. 4,920,176 the acrylonitrile or alkyl derivative monomer should be present in an amount of 0 or 1 to 50 percent by weight based on the total weight of the monomers. The conjugated diene monomer should be present in an amount of percent to 99 percent by weight based on the total weight of the monomers. The nitrile rubbers can also optionally include various co-monomers such as acrylic acid or various esters thereof, dicarboxylic acids or combinations thereof. The polymerization of the monomers typically is initiated via free radical catalysts. Anionic surfactants typically are also added. A suitable nitrile rubber latex is available from B.F. Goodrich under the trade designation HYCAR.

The flexibilizer, if present, preferably is included in the composition in an amount of 5 parts by weight to 300 parts by weight, based on 100 parts by weight phenolic Novolak resin dispersion. More preferably, the flexibilizer is present in an amount of 25 parts by weight to 100 parts by weight, based on 100 parts by weight of the phenolic Novolak resin dispersion.

The modified phenolic resin dispersion can be cured to form a highly crosslinked thermoset via known curing methods for phenolic resins. The curing mechanism can vary depending upon the use and form of the phenolic resin dispersion. For example, curing of the dispersed Resole embodiment typically can be accomplished by subjecting the phenolic resin dispersion to heat. Curing of the dispersed Novolak embodiment typically can be accomplished by addition of an aldehyde donor compound.

The aldehyde donor can be essentially be any type of aldehyde known to react with hydroxy aromatic compounds to form cured or crosslinked Novolak phenolic resins. Typical compounds useful as an aldehyde (e.g., formaldehyde) source in the present invention include formaldehyde and aqueous solutions of formaldehyde, such as formalin; acetaldehyde; propionaldehyde; isobutyraldehyde; 2-ethyhexaldehyde; 2-methylpentaldehyde; 2-ethyhexaldehyde; benzaldehyde; as well as compounds which decompose to formaldehyde, such as paraformaldehyde, trioxane, furfural, hexamethylenetetramine, anhydromaldehydeaniline, ethylene diamine formaldehyde; acetals which liberate formaldehyde on heating; methylol derivatives of urea and formaldehyde; methylol phenolic compounds; and the like.

The composition may be applied to a substrate surface by any conventional method such as spraying, dipping, brushing, wiping, roll-coating, or the like, after which the composition is dried. Since in its preferred form, the coating technique allows the compositions to be applied by autodeposition, the compositions are conveniently applied by dipping the metallic substrate or part into a bath of the composition. The metal substrate can reside in the metal treatment composition bath for an amount of time sufficient to deposit a uniform of desired thickness. Typically, the bath residence time is from about 2 to about 120 seconds, preferably about 2 to about 36 seconds, and occurs at room temperature. The metal treatment composition when it is applied to the metal substrate should be sufficiently acidic to cause reaction with the metal to liberate the metallic ions. Typically, the pH of the metal treatment composition should be 1 to 4, preferably 1.5 to 2.5, when it is applied to the metal substrate. The preferred treatment compositions have a solids content of about 7-8% by weight, based upon the total weight of the composition. The composition typically is applied to form a dry film thickness of 1 to 15, preferably 3 to 10 microns.

After drying, the coated metal surface can be coated with another type of composition. The coated metal substrate typically is dried by subjecting it to heat or forced air. Depending upon the forced air flow, the drying usually occurs at approximately 150-200° F. for a time period ranging from 30 seconds to 10 minutes. Alternatively, the treated metal substrate can be stored for a period of time and then subsequently coated with a different composition.

The coated ferrous metal part may also have an adhesive primer or covercoat applied over the metal treatment. The primer or overcoat does not have to be autodepositable. Conventional, non-autodepositable primers or covercoats can be used with the metal treatment composition. For example, adhesive primers or covercoats such as those described in U.S. Pat. Nos. 3,258,388; 3,258,389; 4,119,587; 4,167,500; 4,483,962; 5,036,122; 5,093,203; 5,128,403; 5,200,455; 5,200,459; 5,268,404; 5,281,638; 5,300,555; and 5,496,884 may be utilized. Elastomer-to-metal adhesive primers and covercoats are commercially available from Lord Corporation of Huntington, Ind. The treatment formulations of the invention may also utilized without any subsequent coating.

Preparation of the dispersed aqueous phenolic dispersions of the type useful in the practice of the present invention will now be described in more detail by way of the following non-limiting examples:

### EXAMPLE 1

### Preparation of Dispersed Novolak Resin

40 g of 6,7-dihydroxy-2-naphthalenesulfonate, sodium salt (available from Andrew Chemicals), 136 g. of a water soluble Resole (made from formaldehyde and phenol, F/P ratio of 2.3, 80% solids and commercially available from Schenectady under the trade designation HRJ11722), 50 g of tert-butyl catechol and 50 g of water were mixed together and steam heated for approximately three and one-half hours until the mixture became very viscous 220 g of resorcinol and 220 g of water were added followed by 6 g of phosphoric acid in 20 g of water. Steam heating was continued for another 40 minutes. 70 g of formalin then was added while continuing steam heating resulting in a concentrate. The concentrate was filtered and self-dispersed upon the addition of 1730 g of water.

### EXAMPLE 2

### Preparation of Dispersed Resole Resin

160 g of 6,7-dihydroxy-2-naphthalenesulfonate, sodium salt (available from Andrew Chemicals), 1000 g of the HRJ 11722 water soluble Resole, and 50 g of water were mixed together and steam heated for approximately three hours resulting in a very thick concentrate. 3600 g of water was added to the concentrate which then self-dispersed and was filtered.

### EXAMPLE 3

### Autodepositable Metal Treatment

The following ingredients were mixed together in indicated wet weight grams to obtain an autodepositable coating/primer:

| | |
|---|---|
| Carbon black | 21 g |
| ZnO | 180 g |
| aqueous Resole dispersion of Example 1 | 400 g |
| Polyvinyl alcohol-stabilized Resole (BKUA 2370) | 600 g |
| Dichlorobutadiene homopolymer | 450 g |
| (VERSA TL/DOWFAX stabilized) | |
| Water | 1000 g |

The following ingredients were mixed together in indicated wet weight grams to obtain a metal treatment used as an activator composition:

| | |
|---|---|
| Aqueous Novolak dispersion of Example 2 | 600 g |
| Phosphoric acid | 400 g |
| Water | 2700 g |

Description of the Protective Coating Process for Ferrous Metal Piping Systems Using an Aqueous Phenolic Dispersion Coating:

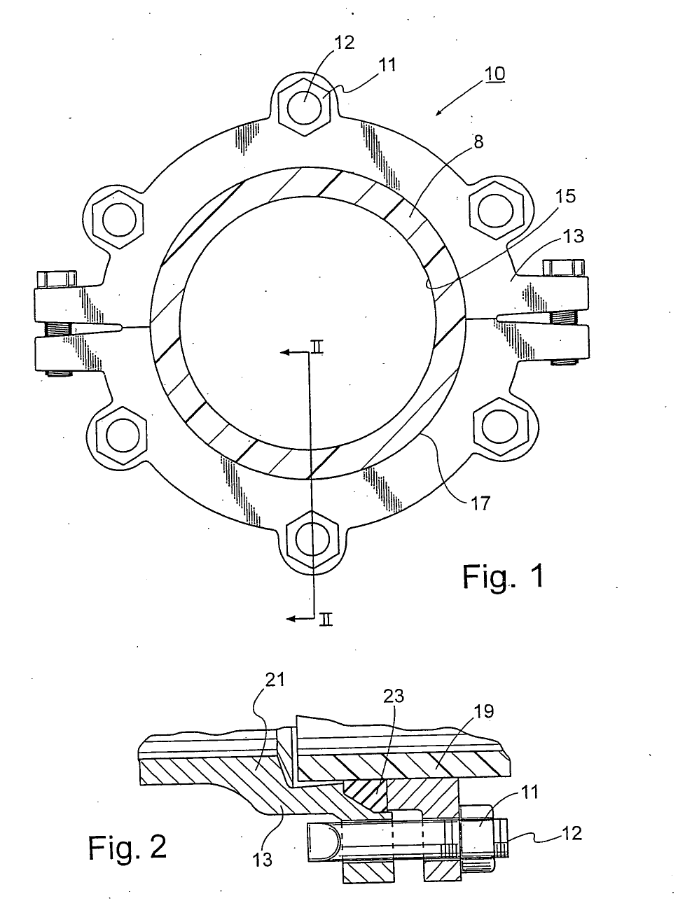

FIG. 1 shows a typical portion of a ductile iron piping system of the type used for fluid conveyance (water, sewage) which would be treated with the coating system of the invention. The piping system includes the ductile iron pipe 8 which is shown at a joint including an external restraining flange or gland 13. The gland 13 is held in place by nuts and bolts 11, 12. The ferrous metal pipe 8 has an interior surface 15 and an exposed exterior surface 17, as well as opposing ends (not shown). FIG. 2 shows a partial cross section of the pipe joint, including a male pipe end 19 which is received within a mating female socket end 21. The external gland 13 and retaining nuts and bolts 11, 12 are also illustrated, as well as the annular sealing ring 23. Any of the exposed ferrous metal surfaces of the pipes, components or accessories of the piping system can be coated using the techniques of the invention.

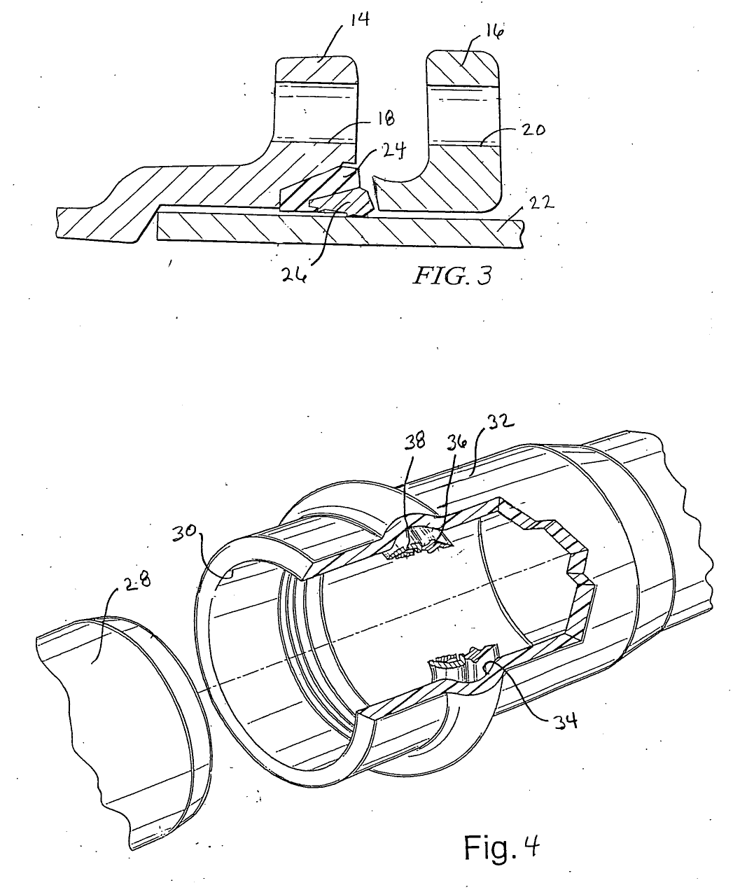

FIG. 3 is a view similar to FIG. 2, but showing a ductile iron flange 14 and bolt ring 16 having aligned bolt holes 18, 20. A male pipe end 22 is shown being received within the female pipe end. In this case, the elastomeric sealing ring 24 is provided with internal metallic gripping elements 26 so that the structure acts as a combined seal and gripping ring for the joint. The gripping elements can also be treated with the aqueous phenolic dispersion coating of the invention.

FIG. 4 is a view of a plastic pipe connection. The connection includes the male pipe end 28 which is received within the mating end opening 30 of the female pipe end 32. The female pipe end 32 has an internal groove 34 which receives a companion seal ring 36 and gripping ring 38. The metallic gripping ring can be coated with the aqueous dispersion coating of the invention.

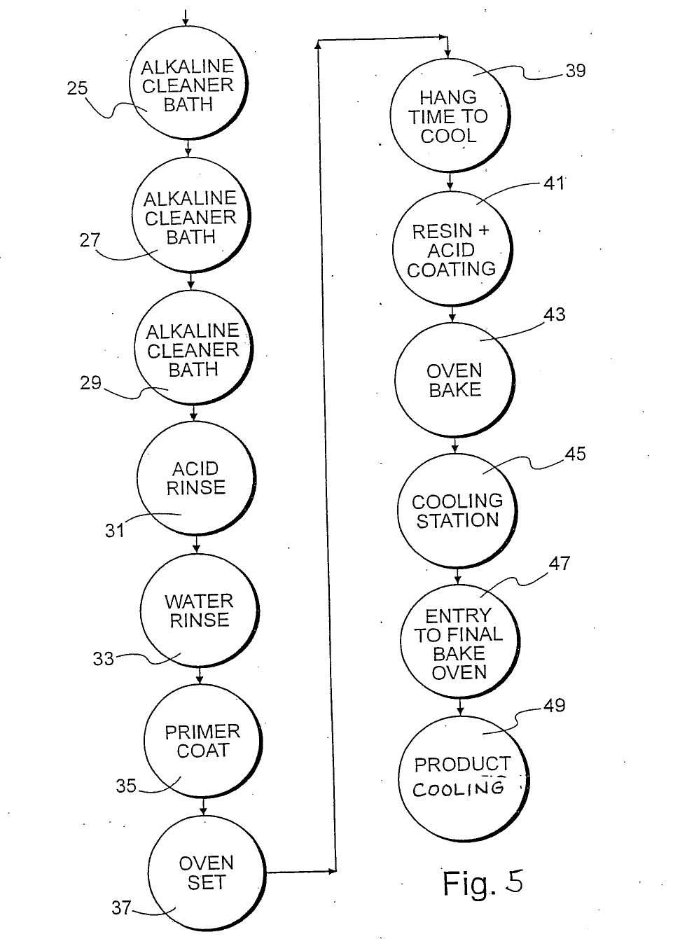

FIG. 5 is a flow chart which illustrates the steps in one typical coating operation of the invention in which a ductile iron gland, such as gland 13 in FIG. 1 is coated to provide improved corrosion protection.

In the first step 25, the metal gland 13 (FIG. 1) is dipped in an alkaline cleanser in a first dip tank for contaminant removal. In this case, the part is exposed to the cleanser in the tank at a temperature of 160° F. for 160 seconds, followed by a 15 second drip time.

In the second step 27, an additional alkaline cleansing step is utilized with the part being dipped at 168° F. for 160 seconds, followed by a 5 second drip time.

In the next step 29, another alkaline cleansing step is employed, this time at ambient temperature for 160 seconds, followed by a 5 second drip time.

In the next step 31, a ZPS (zinc phosphate) acid rinse is utilized to being the iron in the treated part to the surface of the metal.

The next step 33 is the final metal cleansing utilizing city water as a rinse for 20 seconds, followed by a 8-9 second drip time.

In the next step 35, a primer coat for the aqueous phenolic resin described above is applied to the part by dipping the part in a bath at 63° F. for 20 seconds with a drip time of 9 seconds. In this case, the primer coat was a MetalJacket™ 1200 primer.

In the next step 37, the part is conveyed to an oven for setting at 240-250° F. for 12-13 minutes.

The next step 39, represents a hanging time of 4 minutes to allow cooling of the part.

In the next step 41, the corrosion protection coating consisting of the aqueous phenolic dispersion and acid formulation described above is applied to the part by dipping the part in a bath at 65-72° F. for 10-12 seconds. In this case, the aqueous phenolic dispersion was MetalJacket™ 2110 coating.

In the next step 43, the part is baked in a second oven at 240-250° F. for 13 minutes.

In the next step 45, the part is conveyed to a cooling station and hangs for 6 minutes.

In the next step 47, the product is hung on a conveyor belt and fed to a final 130 foot bake oven where it is baked at 400° F. for 20-25 minutes.

In the step 49, the part is allowed to finally cool.

Description of the Powder Coating Process:

Once the metal has been coated with the MetalJacket™ coating, the piping component can be further treated by applying a powder coating to further improve the corrosion resistance of the metal. The powder coating is preferably applied by an electrostatic deposition technique, such as though the use of an electrostatic spraygun to the grounded metal component. Electrostatic deposition techniques, which are the most frequent powder coating techniques, are familiar to those skilled in the art. Electrostatic coating is used to not only provide full body coverage, but also edge coverage. In addition, the final coating thickness is very uniform, even when part thickness varies.

In the typical electrostatic deposition process used in the industry today, the part must first be cleaned as by grit blasting, followed by degreasing. The previously described process for coating the metallic piping components of the invention has the unique advantage that no additional cleaning step, such as grit blasting is required. The phenolic resin dispersion coating, in effect, serves as a replacement for the traditional cleaning step required.

Next, the parts are preheated to a temperature, usually over 400° F., for the resin to be applied. The resin powder composition for electrostatic coating most commonly comprises a thermosetting or thermostatic resin and from 0.01 to 20% by weight of an electric charge-increasing agent. In the typical industry practice, the thermosetting resin may be of a conventional type such as an epoxy resin, a polyester resin or an acrylic resin. Individual particles of resin powder are moved by compressed air through a specially designed gun where they receive a static charge. Lastly, the part to be coated is grounded, producing an electrostatic field between the gun and the part. The powder particles are attracted to the part. As the particles deposit, they insulate the substrate, repelling additional powder and ensuring a uniform film. To finalize the coating process, the loosely coated part is then heated in an oven to above the fusion temperature of the resin in the flow-out step.

The above described powder coating process works well for smaller and irregularly shaped parts, such as the previously described gripping rings. In another known method of powder coating a tubular object, such as sections of a pipeline, a source of heat-meltable plastic material is introduced at a location upstream of the inlet end of the pipe. The first end is closed and the second pipe end is attached to a source of reduced pressure. Compressible fluid is connected at a location upstream of the inlet end of the pipe. The pipe is preheated and then rotated axially while a charge of powdered plastic is forced through the pipe by the compressible fluid.

Another method of applying powder coating if referred to as the “Fluidised Bed” method. In this method, the part is heated and then dipping it into an aerated, powder-filled bed. The powder sticks and melts to the hot object. Further heating is usually required to finish curing the coating. This method is generally used when the desired thickness of coating is to exceed 300 micrometres.

The first described method is preferred in the case of coating parts which have irregular shapes. For example, gripping teeth, metallic spline shafts and metallic gears can be formed with a resin coating to impart wear resistance or corrosion. In the prior art processes, where such a resin coating is formed by a fluidization dipping process, the resulting coating becomes thicker because of the large thermal capacity of the articles. Usually, when attempting to make the coating into a thin film that would cause the coating levelness to lower, difficulty is introduced while trying to form a uniform coating with high precision. After coating such objects to an initial film thickness by a fluidization dipping process, the coating would often be subjected to a machining process to form a coating film thinner than the initial layer. However, this method involves the machining process at the crests and troughs, or roots, of teeth of gears, resulting in not only lowered production efficiency but also increased cost.

The method of the invention, on the other hand, easily allows a thin, corrosion protective coating to be applied to an irregularly shaped part. With reference again to FIGS. 3 and 4, the metallic gripping elements 26 and 38, used in the piping systems described and in this case formed of steel, can easily be coated according to the principles of the invention section. These rows of gripping teeth, present on these parts, illustrate an irregularly shaped surface containing a series of projections and depressions that have historically presented problems with coating. However, the present invention can provide coverage to all surface designs, including teethed surfaces for such gripping inserts.

The coating process of the invention has particular application in providing a cost effective and environmentally alternative to traditional galvanization processes for steel, iron and other metals and metal alloys. Galvanization is presently characterized by rapidly increasing costs, pervasive environmental problems and performance limitations. The present process can provide competitive stable pricing, as well as an environmentally friendly coating process that results in a uniformly high performance coating. The two coat water based system comprising a phenolic resin based and rubber toughener coating can be applied by immersion to steel at room temperature. The chemical bath chemically reacts with the steel to produce a uniform gel. No solvents or heavy metals are employed. The resulting coating can be baked at, e.g., 400° F., to provide a corrosion resistant coating with excellent physical and performance properties.

The preferred multi-step immersion process, as previously described, uses an automated dip application line. The metal substrate to be treated is cleaned with alkaline cleaners. A pretreatment is applied of the phenolic resin system that has been described and the coating is dried and baked. A high performance powder coating is then applied on top of the previously applied phenolic resin coating to produce near stainless steel performance at a more economical price.

Advantages of the Invention:

An invention has been provided with several advantages. The coating system of the invention uses coatings that are autodepositable. When the treatment composition is applied to an electrochemically active metal the acid reacts with the metal to form multivalent ions (for example, ferric and/or ferrous ions in the case of steel) that appear to cause the treatment composition to deposit on the metal surface as a self-limiting, substantially uniform, gelatinous, highly acidic wet film. As the film dries, the remaining phosphoric acid converts the surface to the respective metal compound with the respective negative ion of the acid (for example, metal phosphate in the case of phosphoric acid) forming an interpenetrating network with chelating groups of the aqueous dispersed phenolic Novolak resin.

The autodeposition characteristic is important in providing the required corrosion resistance. It allows for the formation of an exceptionally uniform film. Excellent corrosion resistance is possible only if the entire surface of a metal part is protected with a barrier coating. This requirement is usually difficult to achieve on substrate surfaces that have are curved, irregular, or have internal cavities, such as the teethed surfaces 26 and 38 shown in FIGS. 3 and 4. The autodepositable nature of the coating system of the invention achieves wetting and thus protection of even complex surfaces.

Another important advantage of the metal treatment composition is that a bath of the composition does not appear to change in composition as cumulative metal surfaces are dipped in the bath over a period of time. It is believed that the very hydrophilic phenolic resin dispersion immobilizes or coagulates on the metal surface as a swollen wet gel rather than as a precipitate. This characteristic minimizes the buildup of sludge with the accompanying problem of waste disposal.

The coating techniques of the invention provide extremely effective corrosion protection for ferrous metals of the type used in piping systems for fluid conveyance in the waterworks industry. As compared to prior art treatments, the coatings of the invention adhere under extreme circumstances. Also, the coatings are relatively temperature and humidity tolerant, making control of these variables less critical. Both solvent based and aqueous adhesives can also be used with the coatings of the invention. The preferred powder coatings provide additional corrosion resistance, even when applied in layers as thin as 1-3 mils. The coatings of the invention can provide corrosion resistance comparable to galvanization treatments for steel surfaces at greatly reduced costs.

The coatings of the invention provide an attractive alternative to traditional galvanization processes for steel and other metals and metal alloys. The coatings of the invention provide better corrosion resistance and are weldable with a small heat effect zone. They can also be touched up after welding. They offer excellent dimensional control during application. There is no hydrogen embrittlement since no high temperatures are used which would otherwise drive hydrogen into the crystal structure of the metal. The process does not use strong acids which would generate hydrogen. The additional powder coating step provides near stainless steel performance.

While the invention has been shown in only one of its forms, it is not thus limited but is susceptible to various changes and modifications without departing from the spirit thereof.

What is claimed is:

1. A method of corrosion protecting a steel substrate, the method comprising the steps of:
coating the steel substrate with a corrosion resistant coating which comprises an aqueous phenolic resin dispersion, followed by baking and drying; and
thereafter, applying an electrostatic spray powder coating onto at least selected areas of the previously coated steel substrate.

2. The method of claim 1, wherein the electrostatic spray powder coating is a resin powder selected from the group consisting of epoxy, polyester and acrylic resins.

3. The method of claim 1, wherein the steel substrate is selected from the group consisting of restraint joint devices, nuts, bolts and external wedge devices used in a fluid conveyance system which are formed of steel.

4. The method of claim 1, wherein the coating comprises a continuous aqueous phase and, dispersed within the aqueous phase, the reaction product of a phenolic resin precursor and a modifying agent, wherein the modifying agent includes at least one ionic group and at least one functional moiety that enables the modifying agent to undergo condensation with the phenolic resin precursor.

5. The method of claim 4, wherein the resulting dispersed phenolic resin reaction product includes at least one phenolic ring to which is bound to the ionic group from the modifying agent.

6. The method of claim 5, wherein the modifying agent is selected from the group consisting of sulfate, sulfonate, sulfinate, sulfenate or oxysulfonate and the reactive functional moiety is a hydroxy or hydroxyalkyl.

7. The method of claim 4, wherein the dispersed phenolic resin is selected from the group consisting of Novolak resin and Resole resin.

8. The method of claim 1, wherein the steel substrate is a metal pipe component which forms a part of a water or sewer line used in the waterworks industry as a part of a fluid conveyance system.

9. The method of claim 2, wherein the electrostatic spray powder is applied to the steel substrate directly after the component is coated with the aqueous phenolic resin dispersion and without an intermediate step of blasting, degreasing or cleaning.

10. The method of claim 9, wherein the electrostatic spray powder coating is heated in an oven to thereby fuse the powder to the surface of the pipe component.

11. The method of claim 1, wherein the total thickness of the phenolic resin coating and the electrostatic spray coating on the steel substrate is 20 mils or less.

12. The method of claim 11, wherein the total thickness of the phenolic resin coating and the electrostatic spray coating on the steel substrate is 10 mils or less.
